(19) United States
(12) Patent Application Publication
(10) Pub. No.: US 2022/0143915 A1
(43) Pub. Date: May 12, 2022

(54) OBJECT MODEL DATA MODIFICATION FOR THREE DIMENSIONAL PRINTERS

(71) Applicant: Hewlett-Packard Development Company, L.P., Spring, TX (US)

(72) Inventors: Sergio Gonzalez Martin, Sant Cugat del Valles (ES); Marc Borras Camarasa, Sant Cugat del Valles (ES); Jordi Roca Vila, Sant Cugat del Valles (ES)

(73) Assignee: Hewlett-Packard Development Company, L.P., Spring, TX (US)

(21) Appl. No.: 17/417,734

(22) PCT Filed: Jul. 25, 2019
(86) PCT No.: PCT/US2019/043532

§ 371 Date: Jun. 23, 2021

(51) Int. Cl. B29C 64/379; B29C 64/386; B29C 64/40

(52) U.S. Cl. CPC B29C 64/379; B33Y 40/20; B29C 64/40; B29C 64/386

(57) ABSTRACT

Object model data modification is described in which object model data defining a first object to be generated by a three-dimensional printer may be obtained. A determination whether the first object is an object that may be adversely affected by a post-processing apparatus during post-processing based on a geometry of the first object to be generated can be made; and if the determination is affirmative, the object model data may be modified by adding a structure to the object model data to create a modified object comprising the first object and the structure, the modified object of a different geometry to the first object so as not to be adversely affected by the post-processing apparatus during the post-processing.

### BACKGROUND

Following a build operation to generate one or more printed objects in a three-dimensional (3D) printer, the printed objects may be subjected to post-processing steps. In powder-based 3D printing systems, for example, a post-processing step may include removal of any non-solidified powder that does not form part of a 3D printed object.

### BRIEF DESCRIPTION OF THE DRAWINGS

FIG. 1 is a schematic diagram showing components of a system according to an example;

FIG. 2 is a flow diagram showing a method of generating modified object model data according to an example;

FIG. 3 is a flow diagram showing a method of determining whether a first object may be adversely affected by a post-processing apparatus according to an example;

FIG. 4 is a flow diagram showing a method of obtaining geometry data relating to a first object in an example;

FIG. 5 is a schematic diagram showing a controller and object representation on a pre-printing application controlled by the controller, and part of a post-processing apparatus, according to an example;

FIG. 6 is a schematic diagram showing changes that may be made to the object representation of FIG. 5 by a pre-printing application according to an example;

FIG. 7 is a schematic diagram showing changes that may be made to the object representation of FIG. 5 by a pre-printing application according to an example;

FIG. 8 is a flow diagram showing a method of obtaining modified object model data relating to a first object in an example;

FIG. 9 is an example of a computer readable medium comprising instructions to generate modified object model data according to an example.

### DETAILED DESCRIPTION

In an example of the disclosure, the process of producing a 3D-printed object to a particular specification may include: (i) part and build preparation; (ii) 3D printing; and (iii) post-processing. During the part and build preparation, a digital model of each object to be printed, comprising object model data representing the object, may be generated or received by a pre-printing application that may be controlled by a pre-printing controller. The object model data can define one or multiple 3D geometry models and/or 3D transform matrices including an object model which can position an object to be printed in a 3D printer's printable area. The object model data is in a format that can be read and interpreted by a 3D printer which can carry out a 3D printing build operation. The pre-printing controller may be a programmable logic device (PLD) or other computing device that can carry out instructions. The controller may include multiple processing elements that are integrated in a single device or distributed across devices.

In powder-based 3D printing, after a 3D build is completed, a build chamber may include a plurality of 3D objects, formed from build material solidified by the 3D printer, along with non-solidified build powder from the build operation. In order to remove the non-solidified powder, a post-processing operation may be performed on the build chamber by a post-processing apparatus. In one example, the post-processing apparatus may remove only the non-solidified powder. In some instances, there may be adverse effects on the 3D objects during post-processing. One adverse effect may, in one example, be caused by openings in the post-processing apparatus, where a 3D object may be unintentionally extracted from the build chamber along with non-solidified powder or could be damaged if a small part of a larger object is caught in an opening. For example, an opening may be a hole or other orifice in the post-processing apparatus through which the non-solidified powder that remains in the build chamber can be removed. In another example, a post-processing apparatus may process a 3D object after printing and the post-processing process may unintentionally damage some kinds of objects or portions on objects, for example, such as objects or portions of objects below a certain size, and objects that have fragile features.

In an example, the post-processing operation is a vacuum operation including a post-processing apparatus that is a vacuum cleaner having a mesh with holes in it through which non-solidified powder from the build chamber may be extracted. In other examples, the post-processing apparatus is a vibrating platform having a mesh on which the build is positioned and through which non-solidified powder may be extracted. Other post-processing operations may include, for example, powder automatic reclaim in which powder is to be automatically extracted from a build chamber, and fast cooling which creates conditions that may adversely affect small objects. Other examples of post-processing operations may include bead blasting, or chemical polishing.

Examples disclosed relate to systems and methods for modifying object model data relating to an object or plurality of objects to be 3D printed in a pre-printing operation. Object model data defining an object to be printed by a 3D printer may be obtained. Information relating to the geometry of the object to be printed can be automatically determined in a pre-printing operation and an estimation can be made as to whether it is likely that the object will be adversely affected in a post-processing operation due to its geometry. The geometry may include the size of the object or the size of a portion of the object. In examples, the adverse effect may include passing through an opening of the post-processing apparatus or being damaged by a post-processing apparatus during a post-processing operation due to the geometry information of the object and data relating to the post-processing apparatus. If it is likely that the one of the plurality of objects will pass through the opening or be damaged, the object model data can be modified to reduce the likelihood that the object will pass through the opening or be damaged. In an example, the object model data is modified such that it contains an arrangement of objects to be 3D printed based on size information of the object. The modified object model data may be automatically generated in an efficient and reliable manner.

The object model data may define at least an object to be printed by the 3D printer. In some examples, the object model data may include a plurality of objects to be printed. The objects are to be printed in a build chamber of a 3D printer. To assist in the preparation of the build, the object model data may be modified to include a build envelope within which objects to be printed are to be arranged. The build envelope may, in one example, closely resemble the size and configuration of the printable area in the build chamber. The objects and the build envelope may be represented on a graphical user interface such as a display screen. The objects may be movable within the build envelope to allow re-configuration of the objects such that objects may be rearranged to fit inside the build envelope. For generating the object model data, there can be different criteria to optimise different aspects for efficient and reliable printing. This may include packing density of the objects, distance between objects or the like.

According to examples herein, one criteria may be determining or estimating whether any of the objects in the build envelope are likely to be adversely affected during a post-processing operation, for example, passing through an opening in a post-processing apparatus or being damaged in some other manner.

In an example where the adverse effect is passing through an opening in a post-processing apparatus, the opening may be a hole in the post-processing apparatus such as a vacuum cleaner that has a plurality of holes which can receive particulate therethrough such as build powder using a suction mechanism. The holes may be on a mesh that is provided in a hose of a vacuum cleaner. Each of the holes in the mesh may be of a size that is large enough to allow non-solidified powder from, for example, a build chamber to fit through the hole and to be extracted from the build chamber. Data relating to the size of the holes in the mesh of the vacuum cleaner can be stored. The data may include the cross sectional size of the hole such as the diameter and area of the hole cross section. In one example, the size data may be manually entered so that it is received by the pre-printing application through manual data entry. If all the holes are not of the same size, the largest hole size data or other data that can represent the size of the largest hole in the post-processing apparatus may be obtained. In particular, the cross-sectional threshold size xV of the holes can be predetermined prior to printing and stored in an internal configuration file. The cross-sectional threshold size xV may be a form of data that represents configuration parameters of the post-processing apparatus. The cross-sectional threshold size xV may be represented, in one example, as a length value of a diameter in mm and/or an area value of a surface in mm2.

The pre-printing application may receive the information relating to the objects to be printed and obtain data relating to the post-processing apparatus which in an example is a size of an opening in a vacuum cleaner apparatus. A determination can then be automatically made relating to object geometry data of the objects to be printed. A detection that an object will be adversely affected during a post-processing operation based on the geometry data may be made. In one example, the detection may be if an object will pass through the opening in the post-processing apparatus. The detection may be affirmative if the size of the object in the pre-printing application is smaller than the opening in the post-processing apparatus such as a vacuum cleaner to be used during post-processing in which case the object may be classified as a small object. In one example, this may be achieved by determining whether the model size and/or shape of the object will be smaller than the cross sectional size xv of the holes.

Once a detection that an object will be adversely affected during a post-processing operation based on the geometry data is carried out for all the objects to be printed, a list of objects including a classification of the size of the objects may be generated including a first group of objects that are objects that may be adversely affected by a post-processing apparatus and a second group of objects that include the rest of the objects i.e. those that may not be adversely affected by a post-processing apparatus. The list may be displayed on a display unit and the objects in each group may be highlighted on the display unit and/or selectable by a user.

If it is detected that one or a plurality of the objects is a an object that may be adversely affected by a post-processing apparatus which in the example that the post-processing apparatus is one with holes to receive non-solidified powder is that the object is smaller than the holes of the post-processing apparatus, the object model data may be modified to prevent the object passing through the hole.

In an example, the object model data may be modified by adding a structure to the object model data of an identified object to create a modified object comprising the structure and the objects in the first group, the modified object having a geometry, such as a size, that will not be adversely affected by a post-processing apparatus during a post-processing operation. The structure may be a digital representation of a predetermined structure that is automatically generated and suggested by the pre-printing application and/or be digitally created by a user in the pre-printing application.

In an example, before the structure is added, all or some of the objects may be moved relative to each other, for example, such that those objects that are in the first group and that are spatially arranged relative to each other may be moved to within closer proximity to each other. This can allow the small objects to be packed closely together minimizing the volume they occupy.

In an example, the structure may be a protective housing or cage or frame that surrounds some or all the objects that are small enough to pass through the hole in the post-processing apparatus. The structure may partially surround the objects but to a sufficient extent to keep the objects within the structure and to prevent the object from being adversely affected by a post-processing apparatus during a post-processing operation. The modified object that is created may include the objects from the first group and the structure. The modified object may be of a different geometry to each object in the first group such that the modified object will not be adversely affected by a post-processing apparatus during a post-processing operation. In an example where the post-processing apparatus includes holes to receive and extract powder from a build chamber, the modified object will be of a larger size, or will have a geometry, such that it will not pass through the holes in the post-processing apparatus.

In another example, the structure comprises a removable part to connect to an object in the first group. The removable part may be one or a plurality of connectors such as sprues to releasably connect at least two of the objects in the first group together. Alternatively, at least one object in the first group may be connected with a larger object such as one in the second group, connected to another automatically generated object, or more than two objects may be connected together.

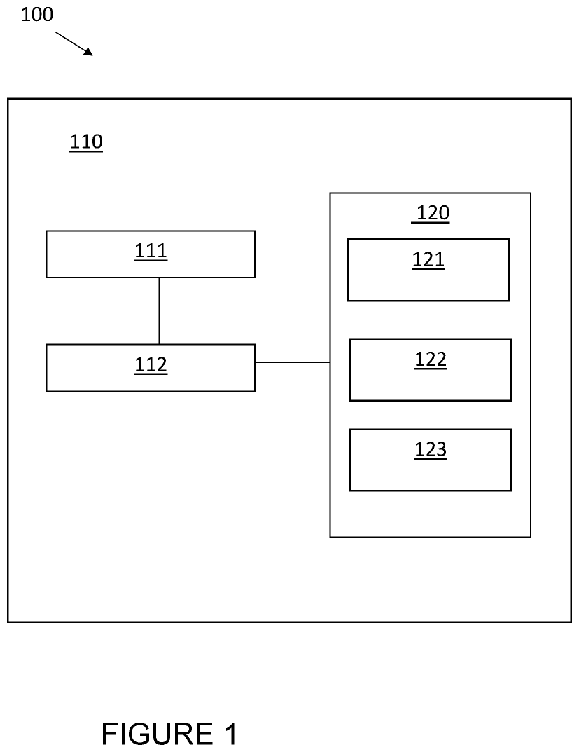

With reference to FIG. 1, there is shown an example system according to the present disclosure. In this example, the system 100 comprises a controller 110. The controller 110 may comprise a plurality of components, some of which are described below. The controller may be a programmable logic device (PLD) or other computing device that can carry out instructions. The controller may include multiple processing elements that are integrated in a single device as described in the example below or distributed across devices.

The controller 110 of the system 100 may comprise a data input/output interface unit 111 to receive input data from external components, for example, user input devices (not shown) to allow a user to interact with the system 100. The unit 111 may also output data from the controller 110 to other external components, for example, a display unit (not shown).

The controller 110 may further comprise a processor 112 to manage all the components within the controller 110, and process all data flow between the components within the controller 110. The processor may be any of a central processing unit, a semiconductor-based microprocessor, an application specific integrated circuit (ASIC), and/or other device suitable for retrieval and execution of instructions.

The controller 110 may further comprise a storage or memory unit 120 to store any data or instructions which may need to be accessed by, for example, the processor 112. The memory unit 120 may be any form of storage device capable of storing executable instructions, such as a non-transient computer readable medium, for example Random Access Memory (RAM), Electrically-Erasable Programmable Read-Only Memory (EEPROM), a storage drive, an optical disc, or the like

In one example, the memory unit 120 includes instructions such as instructions to obtain 121 object model data defining a first object to be generated by a three-dimensional printer, determine 122 whether the first object is an object that may be adversely affected by a post-processing apparatus during post-processing based on a geometry of the first object to be generated, and if the determination is affirmative, modify 123 the object model data by adding a structure to the object model data to create a modified object comprising the first object and the structure, the modified object of a different geometry to the first object so as not to be adversely affected by the post-processing apparatus during the post-processing. If the determination is negative, the controller may analyse another object and carry out the determination for the other object. The modified object model data may be stored for future use by a 3D printer.

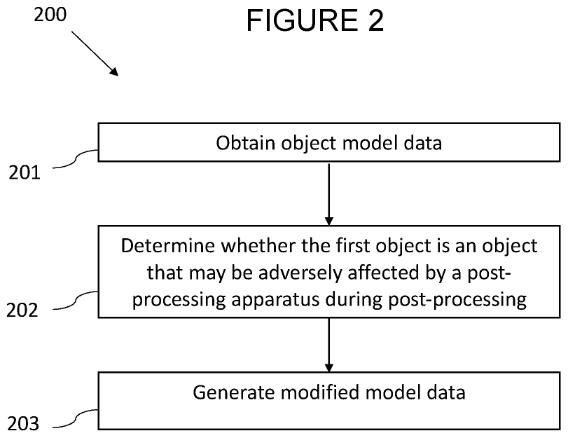

FIG. 2 shows an example of a method 200 for generating modified object model data including an object and a structure that assists in the prevention of the object being adversely affected by a post-processing apparatus during a post-processing operation. In examples, the post-processing operation may be a de-caking operation, a bead-blasting operation and/or a chemical polishing operation. The modified object model data may be output from a pre-printing application that may be controlled by the controller 110 shown in FIG. 1. The method comprises obtaining 201 object model data defining a first object to be generated by a three-dimensional printer. The data may be stored in any suitable manner, for instance, in an electronic file containing information pertaining to the objects including the first object to be printed. The electronic file may be obtained from an external device or a local data store. The method further comprises determining 202 whether the first object is an object that may be adversely affected by a post-processing apparatus during post-processing based on a geometry of the first object to be generated. In one example, the adverse effect may be the object passing through an opening in a post-processing apparatus. In another example, the adverse effect may be likely damage due to the object being small and/or having fragile features. At 203, modified object model data can be generated, by adding a structure to the object model data to create a modified object comprising the first object and the structure, the modified object of a different geometry to the first object so as not to be adversely affected by the post-processing apparatus during the post-processing. The modified object model data may be used to generate slices in a pre-print application which may then be transmitted to a 3D printer, or the slices may be generated within the printer itself based on the modified object model data. The printer may carry out a 3D printing operation on the basis of the modified object model data.

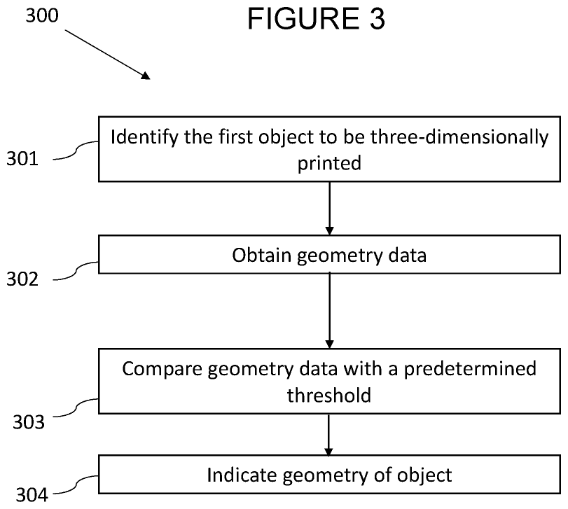

FIG. 3 shows a method 300 including a more detailed example in relation to block 202 of FIG. 2 that may be performed by the controller 110 of FIG. 1 and is an example of a determination of whether the first object is an object that may be adversely affected by a post-processing apparatus during post-processing. The method comprises identifying 301 the first object to be three-dimensionally printed. At 302, geometry data relating to a geometry of all or part of the first object is obtained. At 303, the geometry data is compared with a predetermined threshold geometry xv representative of an object or object portion that may be adversely affected by the post-processing apparatus that will be used to process the first object. At 304, an indication of the geometry of the object such as whether the object is an object that may be adversely affected by a post-processing apparatus during post-processing based on the result of the comparison is obtained. In an example, the indication may be that the size of the object is smaller than the predetermined threshold geometry such that the object is classified as a small object. In another example, the indication may be that the size of the object is larger than the predetermined threshold geometry and the object is classified as not being a small object.

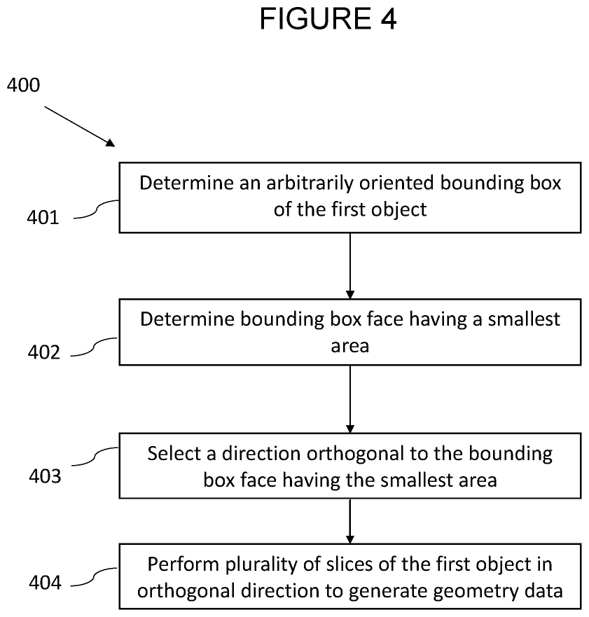

FIG. 4 shows a method 400 including a more detailed example in relation to block 302 of FIG. 3 that may be performed by the controller 110 of FIG. 1 and shows how geometry data relating to the first object can be obtained. The same method can be used for each object. At 401, an arbitrarily oriented bounding box of the first object or part of the first object is determined. In one example, the bounding box may be a cuboid and may be a minimum arbitrarily oriented bounding box relative to the first object. In another example, the bounding box may be a slightly larger bounding box relative to the first object. The bounding box may have a plurality of faces. An area of each face of the bounding box may be calculated. At 402, a determination can be made as to which of the plurality of faces has the smallest or relatively small area compared to other faces. In one example, the bounding box face of the bounding box having the smallest area relative to the area of each of the faces may be determined. In an example, the area of three pairs of faces may be determined instead of the area of all six faces of the bounding box as the size of the two faces of each pair may be the same for particular types of bounding boxes such as rectangular cuboids. At 403, a direction of the smallest size bounding box face may be obtained by selecting a direction orthogonal to the bounding box face having the smallest area. At 404, a plurality of slices of the first object in the orthogonal direction is performed using planes at different heights or distances from the smallest area bounding box face in order to generate geometry data xi relating to the geometry of all or part of the first object, which in one example may be indicative of the size of the first object or a portion of the first object. The plurality of slices may be performed using planes with different orientations at each different height. The geometry data xi may be represented, in one example, as a length value of a diameter in mm and/or an area value of a surface in mm2. The diameter and area value of each plane may be determined. In carrying out the comparing at block 303, the controller 110 may judge that for the object to be adversely affected by a post-processing apparatus during post-processing, which in one example, may be a judgement that the object or part of the object may pass through the opening, the following condition is to be met:

xi≤xV

where xi is value representing as estimate of the cross sectional geometry of part of the object and xV is the predetermined threshold that in one example may be an approximation of the cross sectional geometry of an opening in a post-processing apparatus.

The geometry data xi as obtained in 404 of FIG. 4 may be compared with the predetermined threshold xV at 303 of FIG. 3. In an example, the comparing may include comparing whether a slice of the first object or the part of the first object as obtained in method 400 is larger than the predetermined threshold, and wherein if the slice is larger than the predetermined threshold, the indication in step 304 of FIG. 3 will be determining that the first object will not be adversely affected by a post-processing apparatus that will be used to process the first object during a post-processing operation. If a slice of the first object or the part of the first object as obtained in method 400 is not larger than the predetermined threshold, a different height of the object is sliced in the orthogonal direction and compared at 303 of FIG. 3. This process can be repeated across the different heights from the smallest area bounding box face of the first object or part of the first object that is being analysed. If all the analysed slices are not larger than the predetermined threshold xV, this may provide an indication that the first object or the part of the first object being analysed may be adversely affected by a post-processing apparatus that will be used to process the first object.

Other ways of obtaining geometry data may be used in other examples. In alternative examples, the controller may receive input geometry data from a user, or the controller may receive the geometry data from a predetermined location in its internal memory or through accessing the data from another external location.

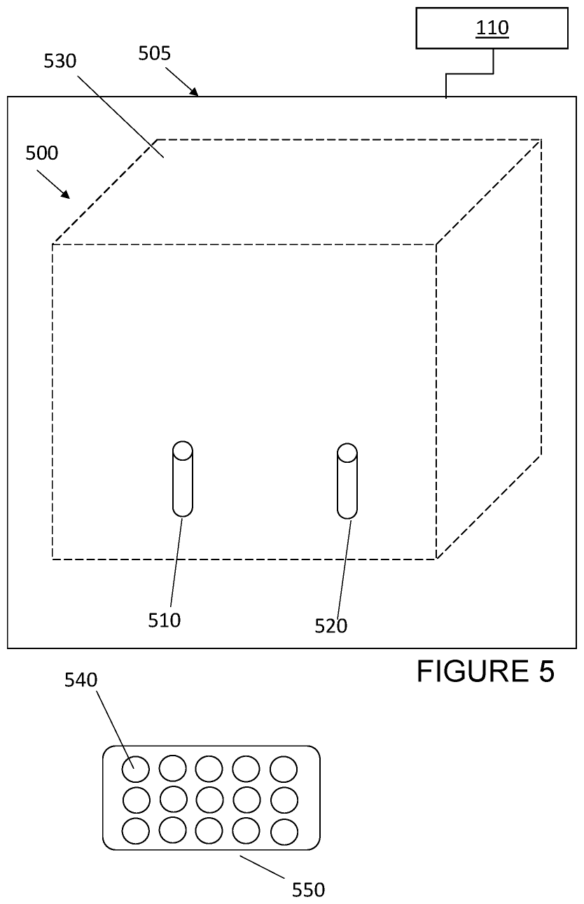

FIG. 5 shows a simplified schematic diagram of the controller 110 and a 3D virtual representation 500, on for example, a display unit 505, of the objects to be printed. Also shown is a top perspective view of part of a post-processing apparatus such as a vacuum cleaner with openings to receive non-solidified powder during a post-processing operation. In the example, there are a plurality of objects defined by object model data, and in the simplified example shown in FIG. 5, a first object 510 and a second object 520 are to be printed and are defined in object model data in a pre-printing application by the controller 110. The simplified diagram shows two objects but more objects may be provided in other examples. The object model data may further comprise data relating to a virtual build envelope 530 which is a virtual representation of a build chamber in a build unit including the objects 510,520 that are to be printed. The controller 110 may cause the display to spatially arrange the first object 510 and second object 520. The controller 110 may determine whether both the first object 510 and the second object 520 will pass through opening 540 of a post-processing apparatus 550 during post-processing based on a geometry of the first object 510 and a geometry of the second object 520 to be generated. The figure shows a post-processing apparatus comprising fifteen openings but other numbers of openings could be provided and the number, size and/or configuration will depend on the particular post-processing apparatus.

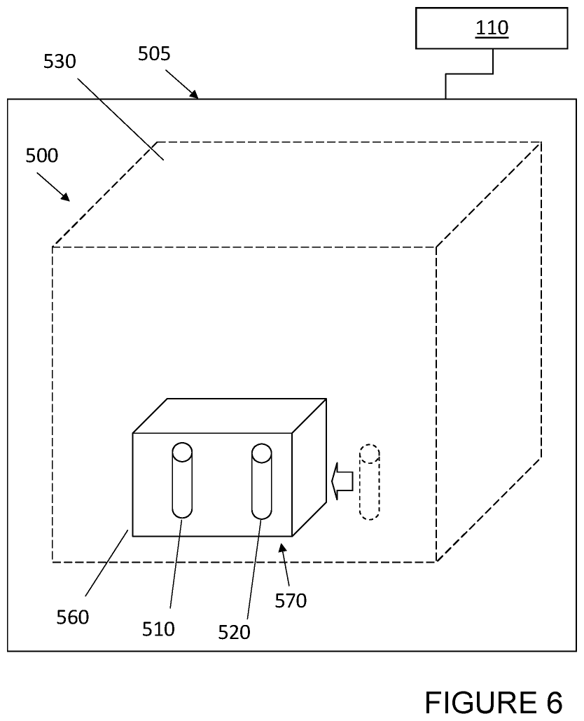

Referring to FIG. 6, the controller 110 may modify the data relating to the virtual build envelope to move the first object 510 and second object 520 relative to each other such as closer to each other to generate first modified object model data if the determination is affirmative. In this example as shown in FIG. 6, the second object 520 has been moved in the direction of the arrow to a different position within the virtual build envelope. The controller 110 may then change the object representation and modify the first modified object model data by adding a structure 560 to the object model data that may surround the first object 510 and second object 520. This may create second modified object model data that comprises a modified object 570 that is of size that will not be adversely affected by a post-processing apparatus during a post-processing operation. In an example, the geometry of the modified object 570 may be such that it will not pass through the opening 540 of the post-processing apparatus 550 shown in FIG. 5. In another example, the structure 560 may prevent damage of and protect the objects 510, 520 contained within the structure 560 during post-processing. In some examples, the structure 560 may be created without having moved the objects relative to each other.

In some examples, the structure 560 may be a digital representation of a predetermined structure that is automatically generated and suggested by the pre-printing application and/or be digitally created by a user in the pre-printing application.

In an example, the structure may be a protective housing or cage or frame that encapsulates some or all the objects that are small enough to be adversely affected by a post-processing apparatus during a post-processing operation.

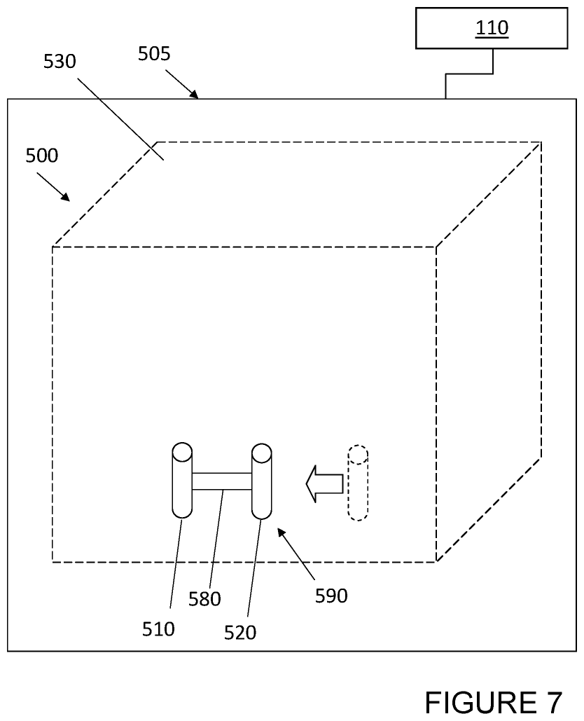

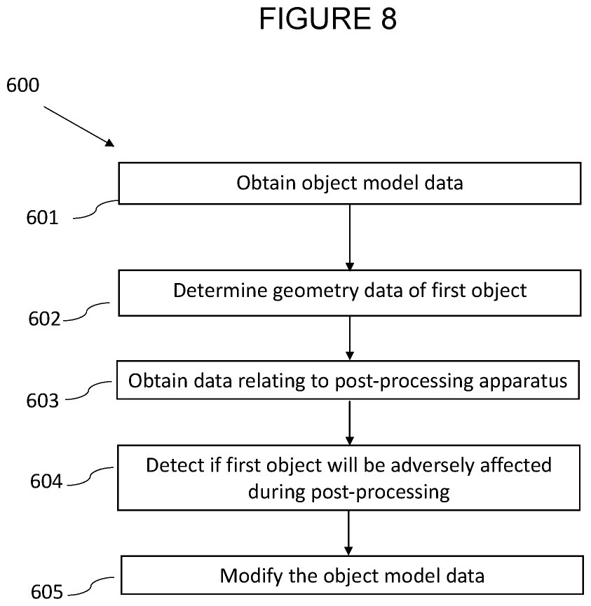

With reference to FIG. 7, in another example, as with FIG. 6, the controller 110 may modify the data relating to the virtual build envelope to move the first object 510 and second object 520 relative to each other such as closer to each other to generate first modified object model data if the determination is affirmative. In this example, as shown in FIG. 7, the second object 520 has been moved in the direction of the arrow to a different position within the virtual build envelope. In this example, the structure comprises one connector 580 such as a sprue to removably connect at least two of the objects such as the first object 510 and second object 520 and in an orientation to create second modified object model data that comprises a modified object 590 that is of geometry that will not be adversely affected by a post-processing apparatus during a post-processing operation. In an example, the geometry of the modified object may be such that it will not pass through the opening 540 of the post-processing apparatus 550 shown in FIG. 5. In the example shown in FIG. 8, the connector is perpendicular to a surface of the object. In another example, the connector may be angled at an acute or obtuse angle relative to the surface of the object. In yet another example, the connector(s) may connect at least one object to a larger object or more than two objects may be connected together to create a modified object that is of a geometry that will not be adversely affected by a post-processing apparatus during a post-processing operation. The connector 580 may be removed from printed objects after the post-processing operation has been performed. In other examples, a plurality of connectors may be removably connected to one or more of the objects. In some examples, the connector may be created without having moved the objects relative to each other.

After the modified object 590 has been generated, it can be packed as build data with any other objects (not shown) located in the build envelope 530 and the build data can be sent to a 3D printing apparatus for printing the objects based on the build data. The likelihood that objects are adversely affected during a post-processing operation may therefore be reduced or removed as a result of the pre-printing process that is carried out according to examples described herein.

In another example method 600 as shown in FIG. 8, at 601, object model data defining a first object to be generated by a three-dimensional printer is obtained. At 602, geometry data of the first object to be printed is determined. At 603, data is obtained relating to a post-processing apparatus. In one example, the data may be the geometry of an opening of part of the post-processing apparatus. At 604, it is detected if the first object may be adversely affected during post-processing based on the geometry data of the first object to be generated and the post-processing apparatus data. At 605, the object model data is modified to create a modified object that is of a geometry that will not be adversely affected during post-processing.

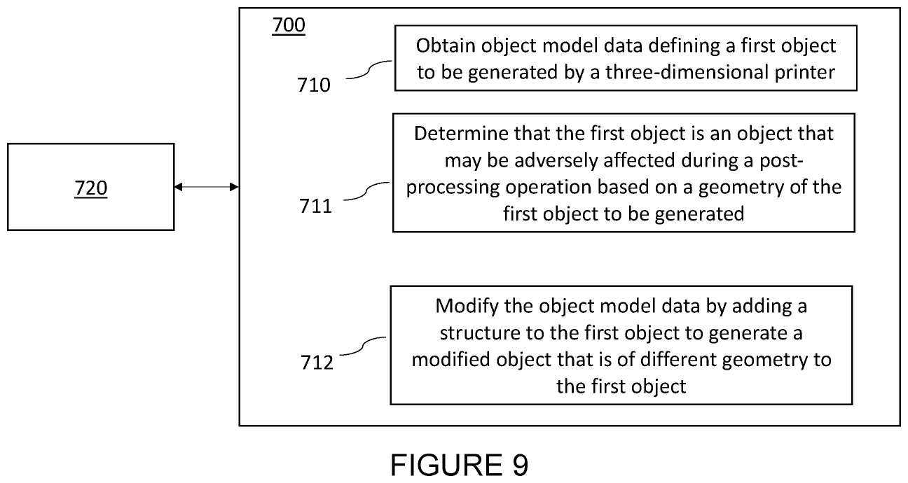

FIG. 9 shows a memory 700, which is an example of a computer readable medium storing instructions 710, 711, 712 that, when executed by a processor 720 communicably coupled to a computing device, may cause the processor 720 to generate modified object model data in accordance with any of the examples or flow diagrams described above. The computer readable medium may be any form of storage device capable of storing executable instructions, such as a non-transient computer readable medium, for example Random Access Memory (RAM), Electrically-Erasable Programmable Read-Only Memory (EEPROM), a storage drive, an optical disc, or the like.

In addition to the examples described in detail above, the skilled person will recognize that various features described herein can be modified and/or combined with additional features, and the resulting additional examples can be implemented without departing from the scope of the system of the present disclosure, as this specification merely sets forth some of the many possible example configurations and implementations for the claimed solution.

1. A system comprising:
a controller to:
obtain object model data defining a first object to be generated by a three-dimensional printer;
determine whether the first object post-processing has a geometry that may be adversely affected by a post-processing apparatus; and wherein if the determination is affirmative,
modify the object model data by adding a structure to the object model data to create a modified object comprising the first object and the structure so as not to be adversely affected by the post-processing apparatus during the post-processing.

2. The system according to claim 1, wherein the structure comprises a housing to wholly or partially encapsulate the first object, or the structure comprises a removable part to connect to the first object.

3. The system according to claim 1, wherein the object model data further defines a second object to be generated by the three-dimensional printer, and the controller is to determine whether both the first object and the second object are small objects that may be adversely affected by a post-processing apparatus in the post-processing operation based on the geometry of the first object and a geometry of the second object to be generated.

4. The system according to claim 3, wherein, after the determination, the controller is to move the first object and second object relative to each other if the determination is affirmative.

5. The system according to claim 4, wherein the structure comprises a housing to wholly or partially encapsulate the first object and second object.

6. The system according to claim 4, wherein the structure comprises a connector to connect the first and second object together.

7. The system according to claim 1, wherein the determination by the controller of whether the first object is an object that may be adversely affected by post-processing apparatus during post-processing, post-processing further comprises:
identifying the first object to be three-dimensionally printed;
obtaining geometry data relating to a geometry of all or part of the first object;
comparing the geometry data with a predetermined threshold geometry representative of an object or object portion that may be adversely affected by the post-processing apparatus that will be used to process the first object; and
obtaining an indication of whether the object is likely to be adversely affected based on the result of the comparison.

8. The system according to claim 7, wherein obtaining geometry data further comprises:
determining an arbitrarily oriented bounding box of the first object or a part of the first object, the bounding box having a plurality of faces;
determining which of the plurality of faces has the smallest area;
selecting a direction orthogonal to the determined bounding box face having the smallest area;
performing a plurality of slices of the first object or the part of the first object in the orthogonal direction using planes at different heights from the smallest area bounding box face to generate geometry data relating to the geometry of all or part the first object.

9. The system according to claim 1, wherein the obtain object model data defines a plurality of objects to be generated by a three-dimensional printer and the controller is to determine whether each object may be adversely affected by a post-processing apparatus in a post-processing operation based on a geometry of each object to be generated.

10. The system according to claim 9, wherein the controller is to classify the objects that may be adversely affected by a post-processing apparatus in a post-processing operation in a first group , and classify the objects that may not be adversely affected by a post-processing apparatus in a post-processing operation in a second group.

11. The system according to claim 10, wherein the structure comprises a housing and wherein the object model data is modified such that all or some of the objects in the first group are wholly or partially encapsulated by the housing.

12. The system according to claim 1, wherein the modified object model data is to be packed for sending to a printing apparatus.

13. A method comprising:
obtaining object model data defining a first object to be generated by a three-dimensional printer;
determining geometry data of the first object to be printed;
obtaining data relating to a post-processing apparatus;
detect if the first object may be adversely affected during post-processing based on the geometry data of the first object to be generated and the post-processing apparatus data,
modifying, on the basis of the detection, the object model data to create a modified object that is of a geometry that will not be adversely affected during post-processing.

14. The method according to claim 13 wherein the modifying further comprises:
moving the first object in the object model data relative to other items in the object model data; and/or
adding a connector to the first object; and/or
adding a cage to wholly or partially surround the first object.

15. A non-transitory computer-readable medium comprising instructions, which when executed on a computing device, cause the computing device to:
obtain object model data defining a first object to be generated by a three-dimensional printer;
determine that the first object is an object that may be adversely affected during a post-processing operation based on a geometry of the first object to be generated; and
modify the object model data by adding a structure to the first object to generate a modified object that is of different geometry to the first object to not be adversely affected during the post-processing operation.
